(19) United States
(12) Patent Application Publication
(10) Pub. No.: US 2010/0096861 A1
(43) Pub. Date: Apr. 22, 2010

(54) Second law energy system

(76) Inventor: Sijo Bak, Vancouver (CA)

Correspondence Address: SIJO BAK, 501-1420 2ND AVE EAST, VANCOUVER, BC, V5N 5L9, CA

(21) Appl. No.: 12/378,319

(22) Filed: Feb. 17, 2009

(51) Int. Cl. H02K 7/18; F03G 7/10

(52) U.S. Cl. 290/1 R; 74/DIG. 9

(57) ABSTRACT

The purpose of the Second Law Energy System (FIG. 2) is to extract gravity and acceleration forces from steadily falling water in a series of containers. The water is pumped up to the water container located at the top of the system by the water pumps. One by one, each water container is fully loaded with water each second and drags down the outer surface of the large cylinder causing it to rotate. This said cylinder is attached with a shaft to the pivot of the cylinder on a fixed horizontal axis. The shaft is mounted on the tower structure with a pair of bearings which connect to the electric generator. This system is comprised of the steel cable wires that work differently from a conventional turbine system. The length of said cable wires shall be longer than two times the length of the circumference of the outer surface of the cylinder. The said cables wires are attached to the water containers using U-shaped clamps or cramping device and hang on the top of the main cylinder, moving together without slipping and pulling down the said main cylinder and the shaft causes it to rotate by the force of gravity on the water in the water containers. This new concept is different from conventional hydro turbines and old mill type turbines. The invention of the Second Law Energy System comprises cable wires to hold water for an extended amount of time in the water containers in order to extract kinetic energy from the falling water in the water containers, allowing the full force of gravity to act on it without touching the main cylinder.

### BACKGROUND OF INVENTION

Applicant (inventor) have been studying the conventional hydro system that exploits the gravity force from the water that falling from high over head through a water tunnel to hit the blades of a turbine will be hard to rotate the turbine at the required rate of velocity. The hitting force is not an accelerating force, it only works for very short moment of time with the velocity of about 43 meter per second to create velocity of the turbine with the very short moment of impulse force, but the water absorbs the impulse force itself. Above said velocity of about 43 meter represent the velocity of the water at the moment of hitting blades from a height of about 100 meters over head through tunnel. Now we think about one ton of water hitting behind a car per second to create velocity of the car and in the other case, a five ton truck dragging the same car with 9.8 meter acceleration rate per second which the same as gravity force, to create velocity of the car. We can compare the two cases. At the first case, the kinetic energy of the water will be ½ mv² . This kinetic energy of the one ton water hitting behind the car each second is constantly the same as at the starting point. In the second case, the five ton truck accelerating at 9.8 meters per second drags the same car as in the first case. But the differences between the two cases are velocity and acceleration and also liquid water and solid object. The first case will not increase velocity of the water any more, just stay on constant velocity of the liquid water at the hitting moment. But the velocity of the truck will be increased gradually by every second. At the starting point on the second case, the velocity of the truck will increase by rate of 9.8 meter per second without dragging the car. This truck will reach velocity of 100 meters per second in about 10 seconds of time. If at the moment a velocity of 100 meter per second is reached, the five ton truck is hooked on to the car to drag the car, terrible things will happen. Alternatively, if we think about increasing the velocity of the car that is dragged by the 5 ton truck with 9.8 meter acceleration rate at the starting point, we won't have the truck speeding up with acceleration rate of 9.8 meter per second. But five tons water can do that by using 9.8 meter per second gravity (acceleration) force just like the five ton truck speeding up at 9.8 meter acceleration rate per second. The above-mentioned five tons of water in the water container falling down free from 100 meter high to the ground will create about 5 Mega joules kinetic energy at the moment of crashing to the floor. One joule is equal to one watts of electric energy. We know the mass of the truck, the acceleration of the truck and the velocity of the truck. Now we can calculate that kinetic energy of the truck will be be

$$E = \frac{1}{2} {mv}^{2} .$$

m is the mass of the truck; V is velocity of the truck. Above mentioned two cases and (FIG. 1) case are very much the same, mass m will be same as the mass of the truck, the cylinder will be the car and one ton of water hitting behind the car. Applicant go back to the conventional hydro system, we find out force of the water per second to hit the blade of the turbine or to hit the same mass of the car is will not be the same as dragging mass M of the (FIG. 1). The truck drags the car the same as the drags or pulling mass M of the (FIG. 1). But the water cannot drag the blade of the turbine but hit the blades of the turbine. We can compare the hitting and the dragging. We can consider how much water will be at the blade within one second when supplying one ton of water every second onto the hit and goes turbine. There will be about maximum one ton of water at the blades every second. At that state of condition F=ma. Kinetic energy will be

$$E = \frac{1}{2} {mv}^{2} .$$

If the velocity of the one ton of the water at the moment of hitting blade is about 43 meters per second at the 100 meter over head, it will produce about 0.9 Mega joules of kinetic energy. The above system will lose some of the force to friction at the surface of the water tunnel. Total kinetic energy will be about seventy percent of the potential energy. Applicant think and dream about the water not escaping after hitting the blades of the turbine and not having to escape for the next tons of the water, there will be greater force to rotate the turbine.

Second low energy system solves the problem to keep the water on the blades for extended seconds of time to accumulate amount of water exploit the gravity force at the same time in every second.

FIG. 1 will show all details of the system and background of Invention. A light flexible rope wrapped several times around a solid cylinder of mass M and radius R, which rotates with no friction, about a fixed horizontal axis, as on the FIG. 1 the free end of the rope is, tied to an object mass m which is released from rest a distance h above the floor. Initially the system has no kinetic energy, but does have potential energy mgh just as mass m strikes the floor, the potential energy is zero, but both this mass m and the cylinder have kinetic energy. The total kinetic energy is

$$E = \frac{1}{2} {mv}^{2} + \frac{1}{2} I {ω}^{2} .$$

The moment of inertia of the cylinder M is

$$I = \frac{1}{2} {MR}^{2} .$$

The tangential velocity of the outer surface of the cylinder related by v=Rω, v is velocity. R is radius of cylinder M, and ω expresses radian or angular velocity of the cylinder. The speed of mass m must be equal to the tangential velocity at the outer surface of the cylinder. Using above relations and sets kinetic energy equal mgh. Now we can be obtained as following.

$$E = mgh = \frac{1}{2} {mv}^{2} + \frac{1}{2} ( \frac{1}{2} {MR}^{2} ) {( \frac{v}{R} )}^{2} = \frac{1}{2} ( m + \frac{M}{2} ) {v}^{2} . \qquad Equation ( 1 )$$

also can be obtained velocity v=\sqrt{2 gh}/(1+M/2m)

Acceleration a=g/1+M/2m). Equation (2)

The kinetic energy is expressed in joules that equal to Watts

When mass M is much larger then mass m, the acceleration is very small. This very small acceleration represent that the velocity will increase by a very slow rate with a very small mass m.

Now we refreshed Newton's Second Law with the system (FIG. 1). The system (FIG. 1) shows that small object can drag down large and heavy cylinder M to rotate with the gravity force. If we can exploit this kinetic energy which drag down to rotate said large main cylinder M, we can generate large amount of electric energy until mass m crash to the floor. Now think about the conventional hydro system. The hit and goes turbine with the pressured water without stay at the turbine and drag down any second. There will be very difficult to create acceleration and to get high velocity of the large turbine. The New system solves the problem that the mass m has to crash the floor.

As above mentioned Newton's equation express of the mass m at the (FIG. 1) system create the kinetic energy by the gravity force which can be dragged down about five hundred times or larger and massive object to rotate with the constant acceleration rate which increase velocity of the cylinder M each seconds. The object m stay hangs longer seconds of time will increase velocity of outer surface of the cylinder M. Amount of energy produced by the gravity force of the mass m will be depend on the time mass m keep stay hang on the steel cable wires, and the velocity of falling object m and mass M that include the cylinder and the shaft and also include amount of tackling force to the electric generator.

### SUMMARY OF INVENTION

The second law energy system has water containers attached with the cable wires hang on the main cylinder which attached to a large shaft at the pivotal horizontal axis that mounted on the between two tall concrete towers or steel structure towers. (FIG. 2). The gravity force created by mass of the water in the water containers which fully loaded water containers will drag down the large main cylinder to rotate continuously unless stop pumping water up to the top empty water container (FIG. 2). The (FIG. 2) show completely assembled this system. We can compare (FIG. 1A) and (FIG. 1B) and system (FIG. 2). It can be recognized the same result can be accrued. The water in the water containers works just same as mass m of the system (FIG. 1A) drag the cylinder down but not crashing to the floor. Instead dispense water at the lower portion of the system and same time new loaded water container arrive at the upper portion of the main cylinder to maintain keep same amount of the water on the (FIG. 2) system. The water will stay in the water containers about five to ten second or longer while grab the gravity force of the water. The total mass M of the said new system (FIG. 2) includes the main shaft and the main cylinder, the water containers and the cable wires, and also includes loading force to the electric generator. The new system of the invention has applied different concept from the water mill type turbine and hit and goes turbine that generate about seventy percent of potential energy because of the not enough moment of time stay onto the turbine wheel with fully loaded water and full vector dragging force. The new system exploit energy of the hundreds tons the mass of the object which falling from high sky endlessly with the same gravity force and accelerate rate. This endlessly represents just same as pump water onto the top empty container steadily.

The diameter of the main cylinder shall be larger as much as possible to get larger moment of inertia of the system and develop higher velocity. The Large and narrow cylinder 1 in the generator room work same as main cylinder works to create moment of inertia. The mass of the cylinder 1(FIG. 2) in the generator room include to the mass M of the main cylinder. Above mentioned system calculated moment of inertia of the rotating main cylinder is

$$I = \frac{1}{2} {MR}^{2} .$$

this main system means (comprises) all the parts attached together on to the main shaft which include the main cylinder and the cylinder 1 which attached to the main shaft and the force or energy loaded to the electric generator using by the cylinder 2 or rpm increase in the generator room. The most of the mass of the system that included loading force to the generator concentrates at the outer surface of the main cylinder will create greater moment of inertia. We knew already about larger moment of inertia of the main cylinder will create the greater kinetic energy at the same RPM. Also larger dia main cylinder is easier to increase velocity of surface of main cylinder and can keep lower velocity to maintain same amount of kinetic energy as smaller and higher RPM main cylinder.

### EXAMPLE 1

Applicant just imagine the mass m of the system (FIG. 1) sets to be one ton and will not crash on to the floor, and just set the mass M probably ten tons and set five hundred tons tackling to the electric generator. The mass M of the system (FIG. 1) plus four hundred ninety tons to the electric generator accumulate together will be about five hundred tons. The acceleration of the above mentioned example 1 (FIG. 1) system shall be, Acceleration=Equation (2). It will be about four centimetres per second acceleration according to the equation which not include friction at the bearings; the velocity of the outer surface of the cylinder will be about two meters per second after about fifty seconds. The one ton mass of the water the (FIG. 1) system will drag down to rotate the mass M of the main cylinder which about two to six hundred times larger the mass than the mass m with the acceleration rate as equation two. We can figure out (FIG. 1) system and (FIG. 2) system are the same conception which object mass m and total mass of the water in the water containers will be same result can be accrued. Applicant will think water in the water containers in full force and mass m of the system (FIG. 1) are the same conception. The water in the water containers will work same as the falling object from space. Above mentioned water in full force represent water at the straight vertical line of the system (FIG. 2) and (FIG. 3). The system (FIG. 1) will create velocity of two meter per second of the outer surface of the main cylinder after about fifty second with one ton mass m and five hundred tons of total mass M which included force tackling electric generator. At this time (FIG. 1) system will creates about 0.4 Mega joules at the moment of the velocity reach at two meters per second, at the velocity of the system reach to five meter per second system will create about 2.5 Mega joules according to the equation of the kinetic energy of rotating cylinder.

Eₖ=Equation (1). Dimensions are mks unit system represents meter kilogram and second. Now work on to FIG. 2); we pump one ton of water per second up to the top empty water containers which four meters apart between one ton capacity of each water container and loading to the generator sets to two thousand tons, total mass of the water will be five tons with five water containers in fully loaded which same as five tons mass m of the system (FIG. 1). Acceleration of the said (FIG. 2) system will be about five centimetres per second. At the time velocity of the above (FIG. 2) system reach four meters per second within 100 seconds of time above system will create about eight Mega joules. These figures are not included friction of bearings and the velocity of the outer surface of the main cylinder increases very slowly because of large amount of tackling force to the generator. The velocity of the system shall increase gradually until maximum loading point reached. In case of loading two hundred tons mass M of main cylinder with five tons full gravity force of the water will accelerate about fifty centimetres per second at the starting point before loading force to the generator that not includes friction of the bearings. The fifty centimetre per second acceleration rate will be too fast at starting point of the system is applicant opinion. Said above system shall start slower and increase loading to the generator until designated velocity to be reached. The pumps consume about half Mega watts to pump one ton of the water each second up to the fifty meter high.

### EXAMPLE 2

The invention of Second law energy system has about twelve to twenty four water containers just for an example (FIG. 3). If each said water containers capable of contain ten tons of water fill in one by one at the every second of the times. Set to five meter between containers and set to twenty meter diameter of the cylinder. And sets to seven water containers in fully loaded with the water which will be about seventy tons which water pumps pump ten tons of water in each second on to the empty water containers at the top of the main cylinder. Total mass of the system included water containers, the mass of the cylinder and the cable wires, the shaft and with the tackling force to the electric generator, all together set to be thirty thousand tons. The acceleration of the above mentioned system will be about 4.5 centimetres per second. The velocity of the outer surface of the main cylinder reach four meter per second after about hundred seconds. This time the (FIG. 2) system will create about one hundred twenty Mega joules kinetic energy. This calculation is based on the moment of inertia

$$I = \frac{1}{2} {MR}^{2} .$$

Above example system can be increased loading force to the generator and can be increased velocity of the main cylinder as needed. Above system will produce about one hundred eighty mega joules at the velocity of five meters per second with thirty thousand tons mass M to the generator that not includes friction at the bearings. The water pumps consume about five Mega watts to pump ten tons per second up to fifty meters Height. The conventional hydro system consumes ten tons of the water per second at about one hundred meters over head will generate about seven Mega watts. This examples show that Second law energy system works a lot more than hit and goes the Conventional hydro systems. Also not needs water reserves. The Invention of the Second low energy system sole exploits gravity force while the water hangs on the cable wires desired seconds of the times with the full gravity force of mass of the water. The production capacity of the Second law energy system depend upon height of the towers, diameter of the main cylinder, size and quantity of the water containers, size and quantity of the cable wires and length, amount of the water supply per second by the water pumps, space between each water container recommend within distance about one to one and half second and all the parts of the system accurately fit and capable to carry the mass and the velocity, also amount tackling force to the electric generator. The mass of the water in the each water container hang on the cable wires could be about ten seconds with full gravidity force will be great. The water in each water container located at the straight vertical line will work in full gravity force to tackles electric generator. The system (FIG. 2) shall start with less force loading to generator until reaching proper velocity of the main cylinder and slowly increase loading to the generator. The ideal loading to the generator at the starting of said system shall be about one to two hundred times of the total mass of the fully loaded water in the water containers that is about ten to twenty centimetres per second acceleration rate at the starting the system. The velocity of the said above system shall be about two to seven meter per second at the normal cruising time that includes friction of the bearings. At the time of accelerating of the system will be less tension at the cable wire ropes located at the downward moving side and lighter loading on to the bearings. According to the Equation. T=mg−ma. The tension at the cable wire ropes will be greater at the fast increase tackling force to loading to the generator with fully loaded water containers and at the breaking system on. The tackling force to the generator shall be increased very slowly to reduce tension at the cable wire ropes. Second law energy system is preferred scale of the tower structure that allows install quantity of water containers, the diameter of the main cylinder works to easy increase the velocity of outer surface of the main cylinder, size of the water containers and larger moment of inertia. The main cylinder works just like turbine and said water containers work same as blades of the conventional hydro turbine. The water of the second law energy system works like this, just sit on the water container and stay a few seconds while gravity and acceleration force work.

### EXAMPLE 3

Applicant has small size turbine second law energy system using by the mass of the cable wire rope dragging main cylinder to rotate.

The (FIG. 10, 11, 12, 13) system will rotate by help of the guide tires rotating by the mass of both sides' wire rope. This both sides means (represent) to pulling force of the left hand side surface of main cylinder portion to downward and right hand side wire rope from the guide tires pulling downward. For incident (FIG. 10) set a 5 meter diameter main cylinder and set guide tires at the one metres apart to the left from center gravity point at the surface of the main cylinder. The force of pulling each side will be about 5:1 ratio. The guide tires shall be very close to the surface of the main cylinder to guide wire rope to get into the pathway of the main cylinder. Guide tires which locate at about one to three centimetres apart from surface of the cylinder and wire rope will not be on the guide tires but just block wire rope to slide in to pathway of the cylinder. Above said guide tires shall be fixed firmly at the tower structure and cross bar on the tower structure. The wire rope will slide through between surfaces of the cylinder and of the guide tires. Force of pulling to left hand side will divide three vector directions, on will be against guide tires side, and one is against surface of the cylinder, and another will be pulling upward. This means that left hand side pulling force will spend more about 50 percent force of the right hand side mass of wire rope because of absorbing force by the guide tires in state of (FIG. 11). Another disturbance force is coefficient friction at the wire rope and surface of the cylinder. There will be about maximum 0.5 coefficient friction rate steel on steel. Lubricated steel on steel will be about 0.16. Also we can apply relativity motion and relativity velocity. Total coefficient friction will be less than about 0.2. For an example, pulling force to left hand side is p=10 kg g. p−0.2p {(1+0.25)+μ v²(1−cos 45⁰)}=x. μ is coefficient friction. (1−cos 45⁰⁾ is relativity motion, v is relativity velocity, v²(1−cos 45⁰) will be about 1.2 at the velocity equal two meter per second. 0.25×0.2 p is absorbing force at guide tire, 0.2 p is mg force to right hand side wire rope to downward and 0.25 is representing 25 percent of mass at right hand side cable wire. In case x>0 at the above equation, the cylinder will rotate to the counter clockwise.

For an example (FIG. 13,); 10 kg mass m of the wire rope at the right hand side will be same as 2 kg mass m of the wire rope at the left hand side pulling force at the point of 5 meter distance from the center gravity of the main cylinder. Sets 10 kg each side wire rope which will be total 20 kg mass of one piece cable wire rope hang on to the (FIG. 13) system. The force of dragging left hand side will be about five times larger than right hand side wire rope, when we set p is left hand side dragging down force, right hand side will be about 0.2 p. Now we can make equation as follow.

P−0.2 p {(1+0.25)+μ v²(1−cos 45⁰)}=x. X will be about 0.7 p If μ is about 0.16 (steel on steel lubricated), (1−cos 45⁰) will be about 0.3, when velocity equal 2 meter per second, μ v²(1−cos 45⁰)=0.2, 0.25 represent 25 percent of mg force (right hand side wire rope) escape to guide tires or wheels which affect dragging force to left hand side dragging force. (it will need more experiment to determine assumption of losing force). This represent that left hand side wire rope will be about 0.7 p greater dragging force than right hand side wire rope. Above calculation showing that 20 kg mass of one set cable wire hang on (FIG. 10) system; system will produce 7 kg mass m of the system (FIG. 1, 2, 3). We can extract about 35 percent mass of the total wire rope of the system (FIG. 10,11, 12,13) and same value to mass m of the (FIG. 1, 2, 3) without pump water. Another way to reduce coefficients kinetic friction is cover up with layer of Teflon (carpet or rugs) at the area sliding two bodies which should give cushion using hard rubber plate on the neat of Teflon. The solid steel cylinder wire rope will slide smooth on the layer of the Teflon sheet that gives soft cushion on the sliding area of the main cylinder. Coefficient friction about steel on Teflon will be about 0.04. Teflon shall be rigid and long lasting materials.

### EXAMPLE 4

We can work together to built a small cable wire rope turbine system. There will need about two meter diameter main cylinder and need at least three guide wheels or tires and twelve meter two tons wire rope and sets like (FIG. 10) on the system. There will be about seven hundred kg surplus pulling mass to the left hand side to downward according to example three before friction on the bearings. Now set 400 times of seven hundred kg will be about two hundred forty tons mass M of (FIG. 1, 2, 3) system. This example system will make about five centimetres per second acceleration rate according to equation (2) before friction of the bearing. The velocity of the said system will be about two meter per second after about 40 second. At this moment, velocity reaches two meter per second, said system will produce about 280 kj. Above system start too small tackling force at the generator can result too fast movement of main cylinder at the starting moment. Applicant recommend install above two identical turbine system at any size ship which capable of carry several tons, and any place and location on the ground on earth without fuel cost and co₂ and long distance transmission line.

The above description and examples should be not construed as limitations on the scope of the invention. Many other variations are possible. Accordingly, the scope of the invention is determined by the clams and their legal equivalents.

### Embodiment

The main cylinder with the main shaft shall be set up and attach together at the top of the tower structure on a set of bearing (FIG. 2). The surface of the main cylinder covered up with the rubber sheet on the pathway of the cable wires with spike to increase dragging force. Said cable wires shall be set on the top of the outer surface of the main cylinder as prepared two separated location and coupled spot of the steel cable wires shall be exactly same line across horizontally. The cable wires coupled both end side together. The width of the water containers shall be shorter than width of the main cylinder slightly. The attachment of the water containers with the cable wires will be very important because of running four different conditions as straight down or straight up and journey together with the main cylinder and curbing at the par below corner. The water containers attached with the cable wires by using coupling device, the U shaped cramps will be one of a kind to choose the way to handle the tension to the cable wires. Also the half cylinder parts of the water containers shall be match with the upside down half cylinder portion of the main cylinder or another shape to build easy is (FIG. 7). In the middle of the surface of half cylinder portion or smaller diameter portion of the main cylinder will be covered up with the rubber sheets (FIG. 5) to easy docking and to increase dragging force with the half cylinder portion of the water containers without sliding. Above said about attaching cable wires with water containers that shaped streamlined same arc with the surface of the main cylinder will be very difficult to build. Another easy way to build is using a bridge over the cable wires in order to free from touch with the main cylinder without arc streamlined shaped portion of the water containers (FIG. 7) and without spare length of the cable wires to fit the arc of the surface of the main cylinder. Supporting legs (FIG. 2) install at the between the main shaft and edgy of the main cylinder to prevent movement of the main cylinder incorrectly. Also attach the spikes (FIG. 7) on to the bridge just beside U cramps at the bottom of water containers to drag main cylinder to prevent sliding and friction. We can install more spikes at the (FIG. 9) in the middle of the between two water containers face to the main cylinder on the steel plates which attached to the cable wires. And a water tank needs on the top of the system to help fill the water in to the water containers by using valve control (FIG. 2). The system of invention has breaking system but shall not attempt to stop the system at the fully loaded water in the containers at the high velocity running state. The system can be used breaking system at the emptied water containers state of the system. The said system will stop with the water valve control.

The (FIG. 10, 11, 12) system needs spikes or material to hold cable wires or ropes on the surface of the main cylinder until separate from the main cylinder.

### DESCRIPTION OF DRAWING

FIG. 1.

(a) This is a drawing of the example equation drawing. The moment of inertia of the cylinder is I=1/2 MR². Newton's second law to mass m yields the relation mg−T=ma, T is tension on the rope. a is acceleration of mass m to downward and surface of the cylinder moving counter clockwise. Mg−½ Ma=ma. a=mg/(m+M/2)=g/(1+M/2m). T=mg−ma=mg/(1+m/2M). At the state of mass M is much larger than mass m, the tension is nearly equal to mg. As showing above equation that maximum tension will be at the stop position of the system with fully loaded water in the water containers.

(b) The water working area with the several fully loaded water containers stay work several seconds to hold cable wires downward and accumulate water to create larger mass m.

FIG. 2.

This is a front view of the second law energy system. 1, Main cylinder. 2, Main shaft. 3, Water containers. 4, Cable wires. 5, Legs located at the between main cylinder and main shaft. 6, Smaller diameter portion of the main cylinder. 7, Half cylinder portion of the water container. 8, Cylinder 1. 9, Rubber covered portion of the main cylinder at the pathway of the cable wires. 10, Rubber blocks at the smaller diameter main cylinder. 13, Steel blocks at the water container to cramp steel cable wires. 14, U shaped cramps. 15, Rubber sheets inserted between steel blocks and cable wires in the U cramps. 17, Bridges over the cable wires beside U cramp in order to make easier than streamlined water containers that prevent tension on to the cable wires between two bridges at the main cylinder without touching to surface of main cylinder, 18, Spikes at the top of the bridges beside U cramps. 20, Generator. 21, Water tank. 22, Tower structure. 23, RPM increaser. 24, Shaft to the generator. 25, Steel plates for additional spikes at the between two water containers attached to the cable wires. 26, Work station. 27, The trench shaped smaller diameter portion of the main cylinder works same purpose as the half cylinder shaped portion of the main cylinder. 28, Cable wires supporting to balance water container. 29, Supporting cylinder. The Cylinder 1 will be connected to the rpm increase in the generator. This (FIG. 2) is complete assembled system of the invention but not showing opposite side water containers. The main cylinder and water container separate at the point of maximum dragging gravity force of the water and stay hang on the cable wires as desired until reaching at the dispensing water around the ground. The water containers move on to the top of the main cylinder again to refill the new water.

FIG. 3.

This is a side view of the system. The half cylinder portion of the water containers shall be longer than front side water container to make balance weight of the water in the containers.

FIG. 4.

This is an enlarged view from top to inside water container. Cable wire (4), rubber covered portion of main cylinder (9), rubber block attached at the edge of the main cylinder for easy smooth docking with water containers. It will protect water containers at the time of docking together and increase holding force each other.

FIG. 5.

This is an enlarged view of the main cylinder of the system with the main shaft. The half cylinder portion of water container (7) will fit exactly on to the edgy to the small diameter main cylinder and to prevent scraping metal together when docking at the main cylinder. Rubber covered portion of the main cylinder and rubber belt in the middle of the smaller diameter main cylinder (10). The force of the dragging to rotate main cylinder will be greater with rubber plate on the surface of the main cylinder which drag down by press downed cable wires with the spike (17) that attached on the bridge beside U shaped clamps (14). Rubber or steel block (16) inserted between inside U cramps to prevent slip water containers from cable wires, there will be supporting braces (18) at the U cramps at both sides. The bridge work to prevent press down cable wires by the pathway of the main cylinder and install some pieces of the spikes on to the two bridges at the one water container. The system will stay hold each other and travel together until separation at the fully loaded water in the water container.

FIG. 6.

This is an enlarged view of the water containers from front and back side view

FIG. 7.

This is an enlarged view in front, cable wires attached with water containers and steel plate. (28) are cable wires to hold straight vertical line when filled water in containers, (29) are rubber blocks outside of the half cylinder help to smooth docking with the main cylinder in case touch together.

FIG. 8.

This is an enlarged view from the back side of the water container with the bridge over the cable wires and installed the spikes on the top of the bridges. Small cylinder attach to the bridges to comport cable wire at the dispensing water area.

FIG. 9.

This is an enlarged view of assembled three dimensional looks without tower structure.

FIG. 10.

This is a side view of complete assembled above wire rope system with tower structure.

FIG. 11.

This is a side view of the rope and cable turbine of the second law energy system. These are the means to the rope and cable turbine of the second law energy system. 1, main shaft. 2, surface of the main cylinder covered layer of Teflon on the rubber plate. 4, guide tires. 5, steel wire rope. 6, tower structure. 7, inside wire rope. 8, cross bar that for the guide tires to be fastened. 9, lower guide tires. The cable wire press down pathway of the main cylinder which covered with sticky material or rubber plate to hold the cable wire rope and drags the main cylinder to rotate. The guide tires fastened at the tower structure and cross bar on the top of the tower structure.

FIG. 12.

This is a top view of the rope turbine system with two lines of wire rope.

FIG. 13.

The velocity of cable wire and velocity of surface of the main cylinder are same but angled about 45⁰. The relative velocity of the two moving body at the sliding spot will be v_{R}=v(1−cos 45⁰), coefficient relativity motion will be μ(1−cos 45⁰).

1. The Second Law Energy System is comprised of a main cylinder shaped like (FIG. 2) attached to the main shaft which set on to the between two tall structures to rotate aiding by a couple of the bearings, said the main cylinder rotates by the force of gravity of the water in the water containers that are attached to steel cable wires using by means for attaching, could include U shaped coupling clamps, welding, above said the water containers hang on said the main cylinder and are pulled down towards the ground and move up to the top of the main cylinder after dispensing the water in the water container and being refilled with water again to maintain the amount of water that is pulled down the said main cylinder in order for it to rotate steadily with the same acceleration rate, means to attaching said cable wires and said water containers need to insert a rubber block or steel plate between said the steel cable wires and said the water containers in order to ease the touching spot, to touch wider spot to hold and need braces at the U shaped cramps for the sharp curving force onto the said steel cable wires at the near the ground, said the outer surface of main cylinder on the pathway of the said the steel cable wires cover up using by rubber plates in order to prevent slippage and to increase the dragging force against the spikes that are attached to the on the neat of the coupling means or on the bridges beside cramping device to the said water containers and said the steel cable wires, above said the spikes are made from material selected from the group consisting of metal, or any other material to prevent slip and to increase dragging force to the main cylinder, above said the surface of the bottom part of the water containers are streamlined or install two bridges (FIG. 7) over the cable wires in order to prevent press down by the pathway of the main cylinder to reduce tension at the cable wires, said above the water containers and said main cylinder are consist of similarly shaped half cylinder type portion which cause them to easy dock and to travel together with pressing each other and guide each other until they separate at the said water containers are fully loaded with the water, these said water containers can be shaped as in (FIG. 6) as example or can be changed as required. Above said this new system can be expressed shorter sentence that is this new system consist of the cable wires and water containers which travel with the main cylinder or travel independently without touching to the main cylinder and extract gravity force of the water in the water containers.

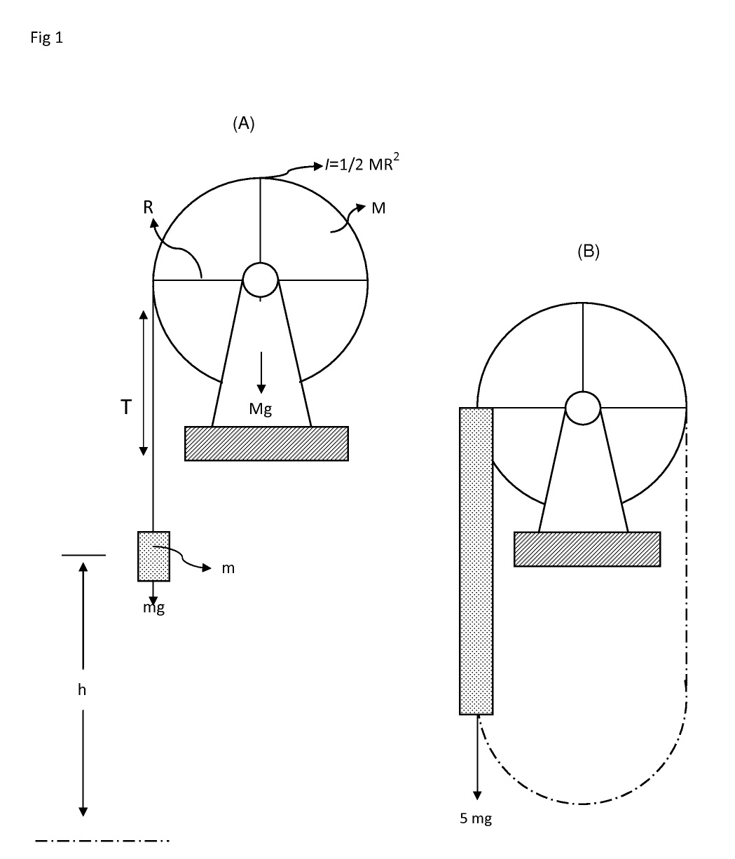

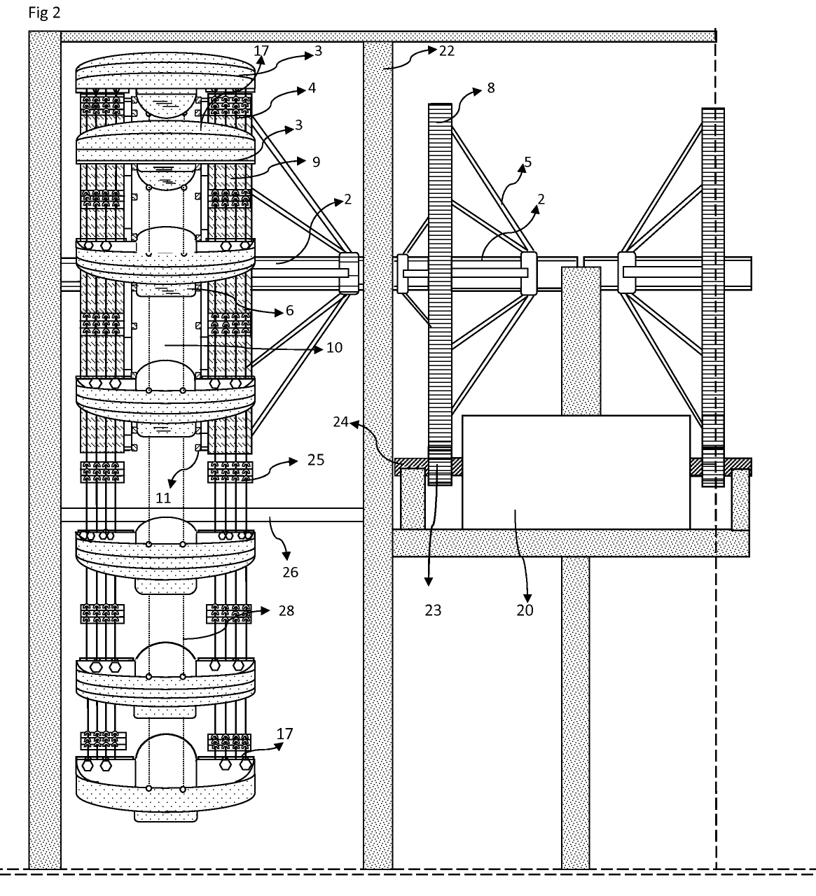

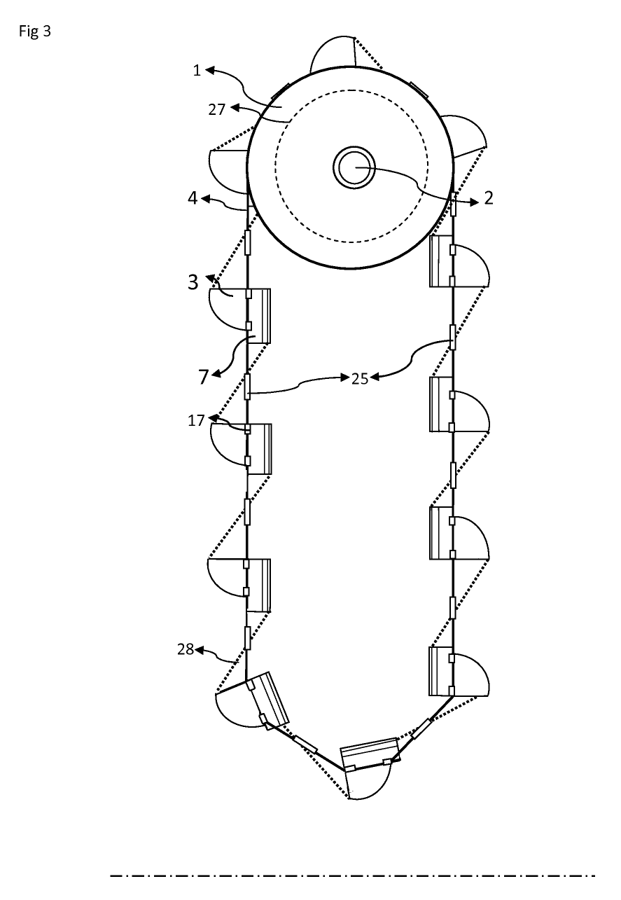

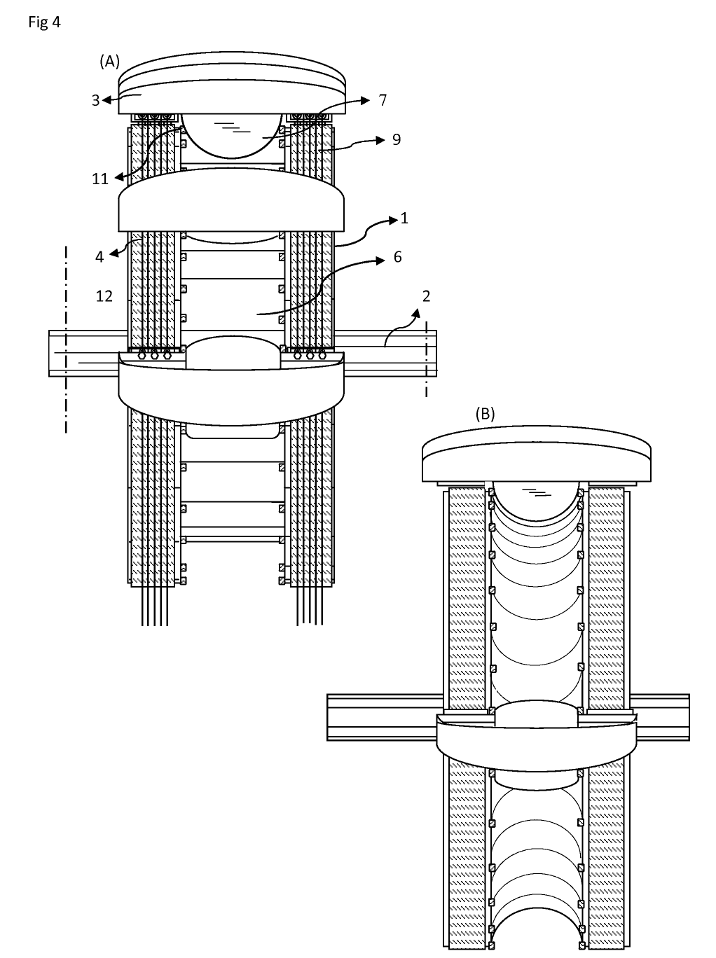

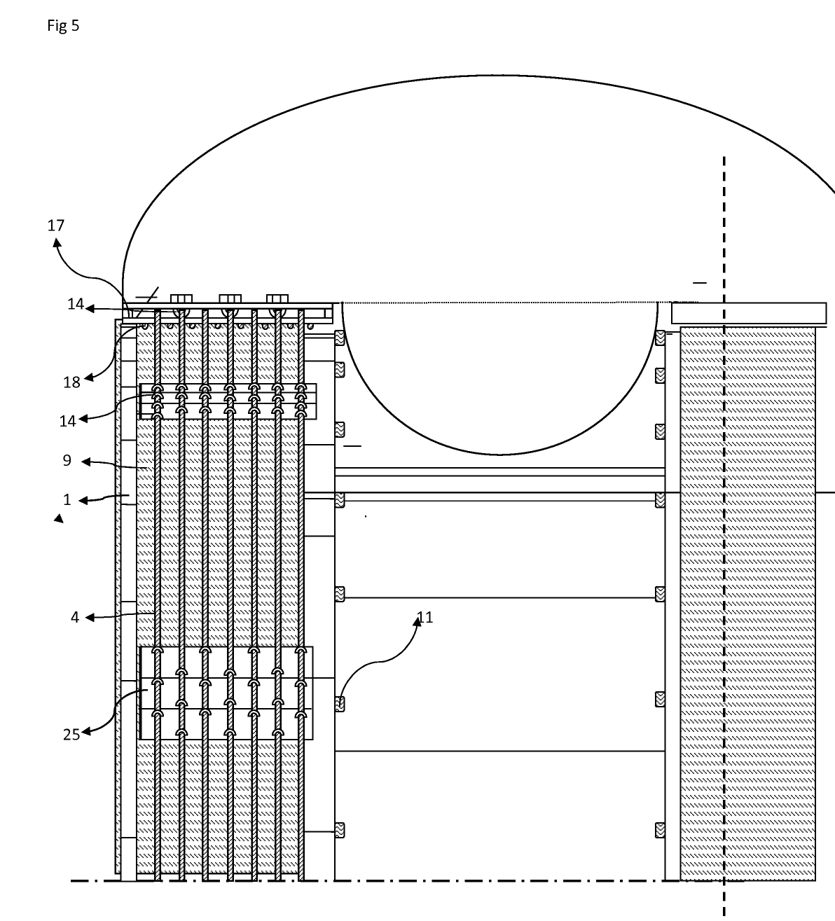

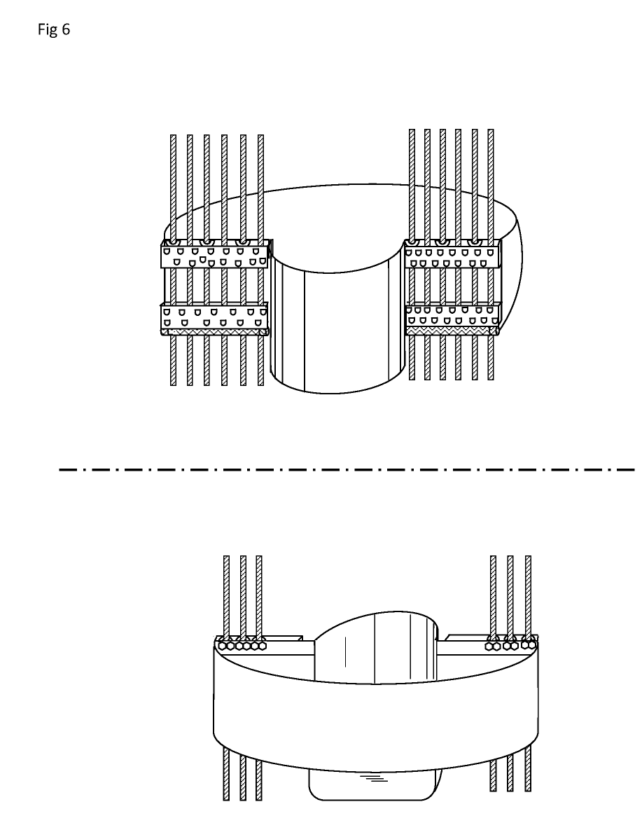

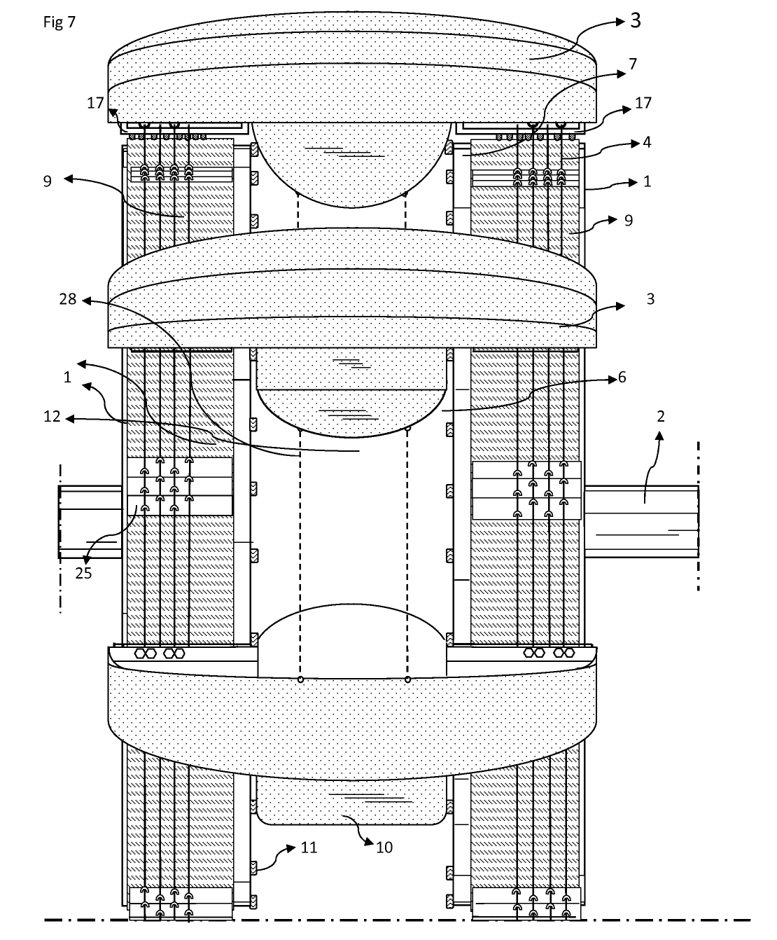

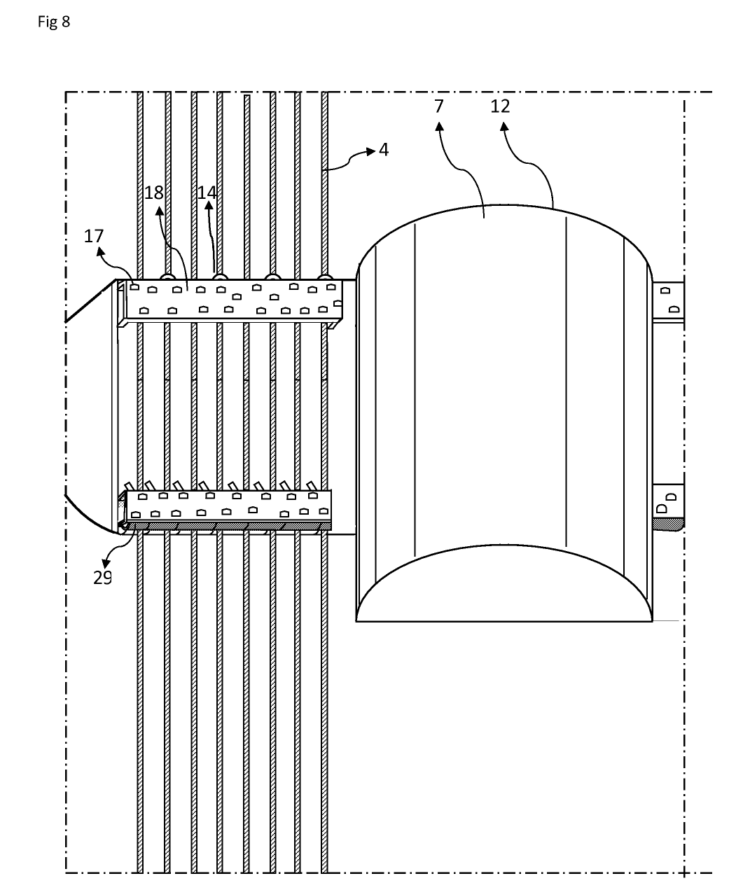

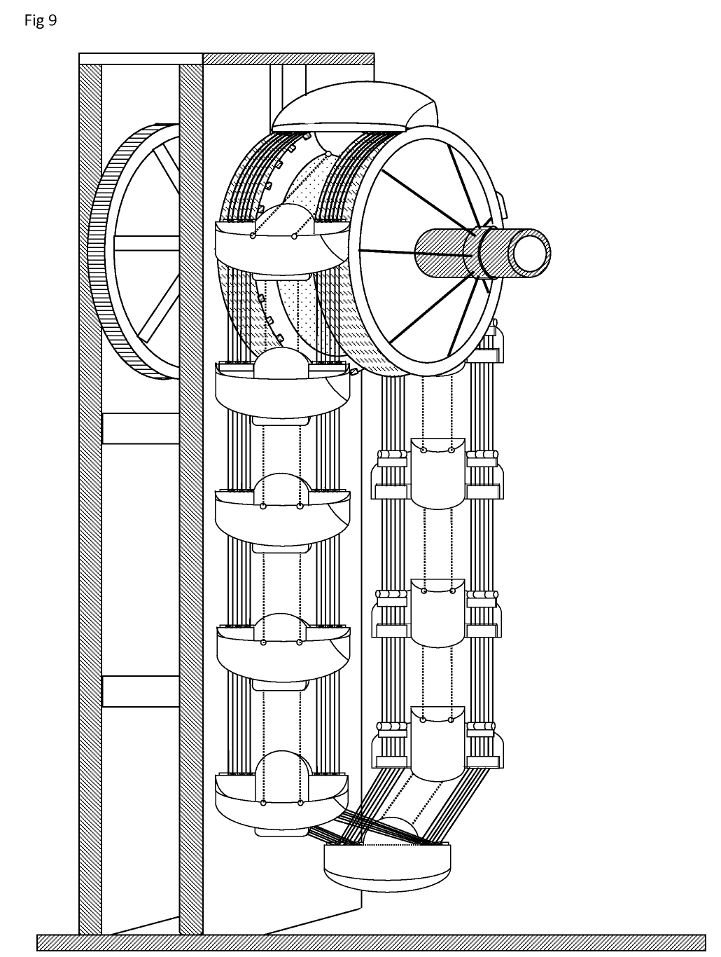

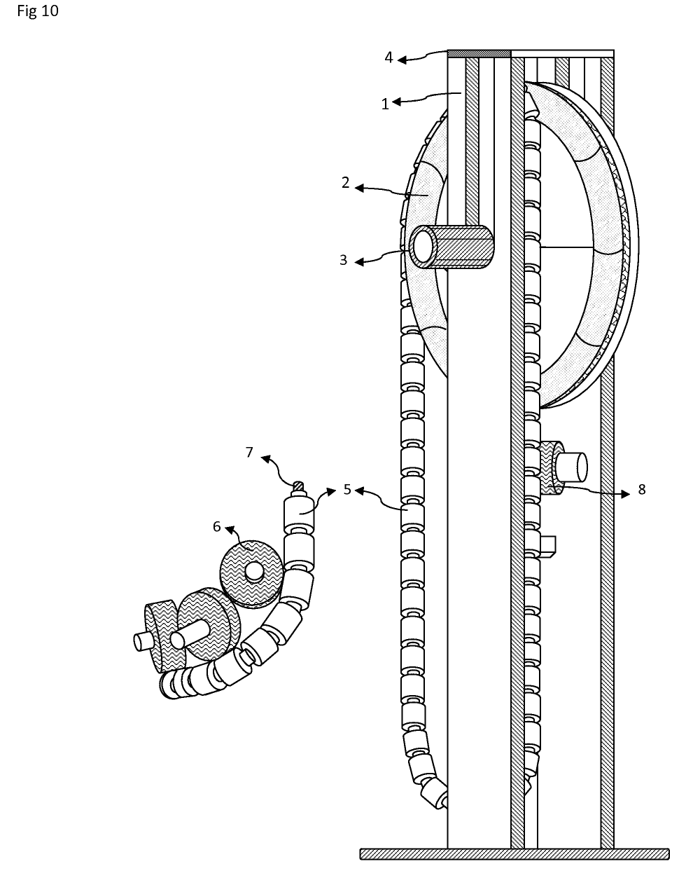

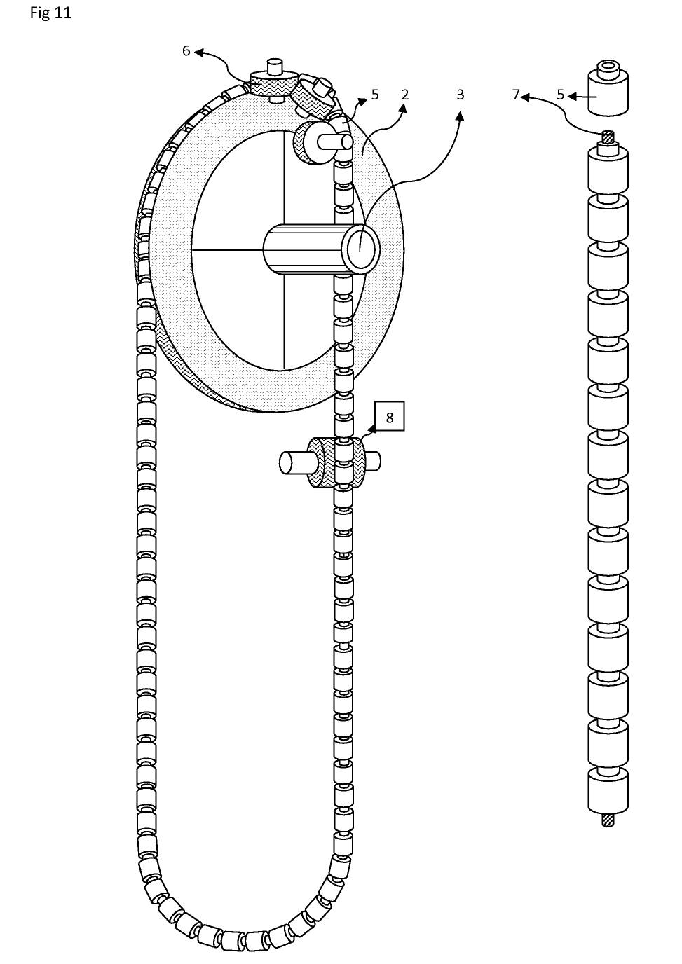

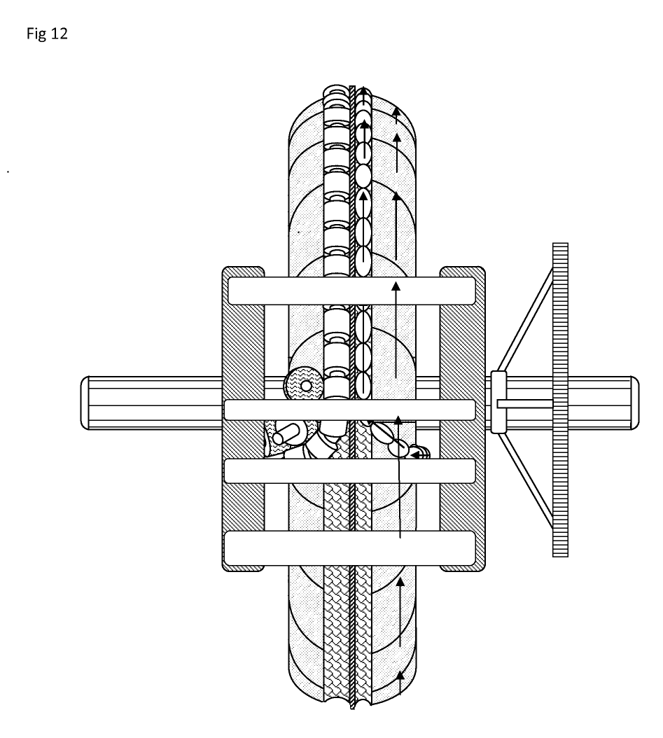

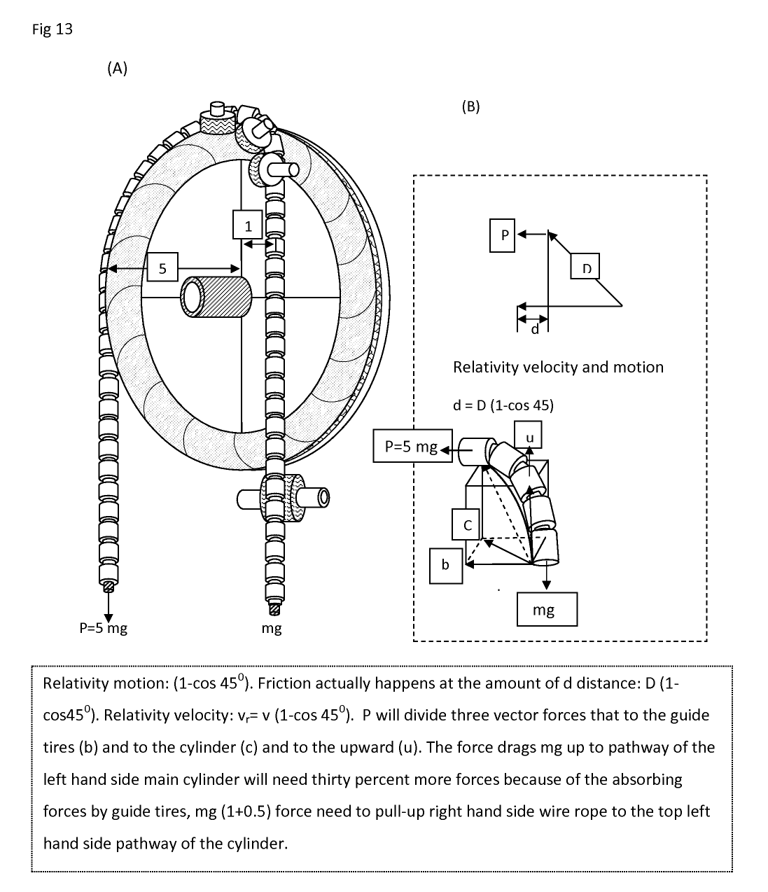

2. This system has exactly same identical conception and principle as the system (FIG. 1,2,3) except without water containers and water pumps to get the mass m for the gravity dragging force, but this wire rope system (FIG. 10, 11, 12, 13) extract force from the mass of the wire rope or solid cylinder wire rope to rotate the main cylinder using with the guide tires which transfer the wire rope short cut onto the pathway of the cylinder to reduce dragging force of the guide tires side mass of the wire rope, compare both side pulling force with the mass of the wire rope on the main cylinder and mass of the guide tires side pulling force which pulling down from the spot of guide tires located at the right side from center gravity point with the mass of the right hand side wire rope. There will be about same mass of the cable wire both side from the center gravity line on the top of the main cylinder to the left hand side and right hand side, but system (FIG. 10,11,12) will show great difference amount of dragging force or torque because of the two different distances from the center gravity point. For an incident, five meter radius main cylinder side wire rope will produce about 5 times force of one meter distance wire rope to the right hand side pulling force. The (FIG. 10, 11, and FIG. 12) system explain about the detail of the claim 2 systems which applies same concept and principle from the moment of inertia to Newton's Second Law (FIG. 1, 2, 3). This system has a few disturbance forces arising at the guide tires that separate main cylinder with two parts, left and right. When the wire rope slide into main cylinder through the guide tires, Force of pulling to left hand side will need more force to handle absorbing force at the guide tires. This will be about fifty percent of the right hand side dragging force of wire rope. If we set one ton mass m both side of the main cylinder. P is left hand side pulling force and right hand side pulling force of wire rope will be about 0.2 p at 5:1 ratio distance from center gravity line. Simple instance calculation will be p−0.2 p {{1+0.25)+μ v²(1−cos 45⁰)}=x. 0.2 P is pulling force to right hand side, v(1−cos 45⁰) is relativity velocity at the two moving object, relativity motion will be (1−cos 45⁰). X will be extra pulling force to the counter clockwise after make balance with right hand side wire rope. In case we get x=0.7 p. Extra force of mass to the left hand side will be 0.7 tons. These 0.7 tons will be same as mass m of the system (FIG. 1, 2, 3). And another disturbance force is coefficient friction force at the surface of cylinder and wire rope. Coefficient friction rate will be about 0.5 at the steel on steel. Lubricated steel on steel will be about 0.16. We can reduce friction rate using by smooth sliding material like layer of texture (Teflon) on the top of rubber plate to reduce friction. Coefficient friction steel on Teflon will be about 0.04. Details will be at the summary of invention.

3. The wire rope or chain shall be heavy weighted for the wire rope turbine system. The easy way to make a heavy wire rope is using series of the metal solid cylinder that have a hole in the middle connect with the cable wire that shaped like necklace wire rope. The (FIG. 11) showing approximate figure metal solid cylinder necklace shaped wire rope. Another way to make heavy rope will be using solid steel ball connect the same.
